(19) United States
(12) Patent Application Publication
(10) Pub. No.: US 2012/0047232 A1
(43) Pub. Date: Feb. 23, 2012

(54) METHODS AND SYSTEMS FOR MEDIA DATA ACCESSING IN AN INTRA NETWORK, AND COMPUTER PROGRAM PRODUCTS THEREOF

(75) Inventors: Chih-Lin HU, Taipei City (TW); Hsin-Cheng Lin, Taipei City (TW); Bing-Jung Hsieh, Yilan County (TW); Yu-Feng Hsu, Taoyuan County (TW)

(73) Assignee: NATIONAL CENTRAL UNIVERSITY, TAOYUAN COUNTY (TW)

(21) Appl. No.: 13/073,534

(22) Filed: Mar. 28, 2011

(30) Foreign Application Priority Data
Aug. 19, 2010 (TW) TW99127689

(51) Int. Cl. G06F 15/16

(52) U.S. Cl. 709/219

(57) ABSTRACT

Methods and systems for media data accessing in an intra network are provided. The intra network is coupled to at least one universal plug-and-play (UPnP) device and a gateway and the UPnP device communicates with the gateway using the UPnP protocol. First, the UPnP device issues a request to the gateway. Then, the gateway performs a data download operation with a device in an external peer-to-peer (P2P) network to obtain a media data therefrom according to the received request.

### CROSS REFERENCE TO RELATED APPLICATIONS

This application claims priority of Taiwan Application No. 099127689, filed on Aug. 19, 2010, the entirety of which is incorporated by reference herein.

### BACKGROUND OF THE INVENTION

1. Field of the Invention

The invention relates to methods and systems for media data accessing, and more particularly, to methods and systems for media data accessing capable of performing a peer-to-peer (P2P) downloading on an external P2P network in a home network.

2. Description of the Related Art

More and more families install home gateways that connect digital equipments at home to make a home network as broadband Internet becomes more common and the demand for becoming a digital family increases. The home network allows automatic control, security monitoring, and home care services. In the home network, devices that support a universal plug-and-play (UPnP) protocol may discover and communicate with each other. UPnP is a set of network protocols. It is based on the concept of plug-and-play. Once the device connects to the intra network (e.g. a home network or an enterprise network), it is able to discover and communicate with other UPnP devices without extra set-up or annoying procedures. In addition, the device using UPnP protocol may automatically obtain an IP and broadcast to other devices so as to automatically communicate with other UPnP devices. Generally speaking, the UPnP devices may classify into two types: Control Point (CP) and Device. Control point may control the actions of the device side and subscribe to action change events of the device side. Control point may also connect two devices and transfer information between them. Take UPnP AV (Audio/Video) for example. Control point may set up an out-of-band connection between media server and media render for streaming. Therefore, as long as there is a render device (such as PC, Xbox, and etc.), media streaming can be played.

Among various uses of the Internet, transferring and sharing data between different computers on the Internet is a common and practical use. In recent years, the peer-to-peer (P2P) data transfer becomes very popular due to fast transfer speed, a variety of data types, and the collective capacity of many users' to operate at the same time. In general, when performing a P2P data transfer, computer devices, such as personal computers or laptops, may configure and download designated data through software that supports P2P transmission. For example, BitTorrent (BT) is a commonly used P2P software. When a user wants to download some files, the user may open the BT software in the computer device to set up download information. The BT software may then download designated files according to the setting of download information including file name, connection location to be downloaded from, and so on.

However, current Internet P2P sharing software cannot directly connect with the UPnP devices in the home network. In addition, data between UPnP devices in the home network may only transmit in the available coverage of a local area network (LAN). Moreover, current digitalized home network and an external network are separated. The two different networks reply on a residential home gateway for connection. However, a current residential home gateway is not able to support formats or specifications of cross-network multimedia sharing.

### BRIEF SUMMARY OF THE INVENTION

Methods and systems for media data accessing in an intra network are provided.

An embodiment of the invention provides a method for media data accessing in an intra network, wherein the intra network is coupled to at least one universal plug-and-play (UPnP) device and a gateway, and the UPnP device communicates with the gateway using the UPnP protocol. The method comprises the following steps. First, the UPnP device issues a request to the gateway. Then, the gateway performs a data download operation on a device that exists in an external peer-to-peer (P2P) network to obtain a media data therefrom according to the received request.

An embodiment of the invention also provides a system for media data accessing. The system comprises an intra network, a gateway and at least one universal plug-and-play (UPnP) device. The UPnP device is coupled to the intra network, and the gateway is coupled to the intra network, wherein the UPnP device communicates with the gateway using a UPnP protocol. Wherein, the UPnP device issues a request to the gateway such that the gateway performs a data download operation on a device in an external peer-to-peer (P2P) network to obtain a media data therefrom according to the received request.

Methods and systems for media data accessing may take the form of a program code embodied in a tangible media. When the program code is loaded into and executed by a machine, the machine becomes an apparatus for practicing the disclosed method.

### BRIEF DESCRIPTION OF THE DRAWINGS

The invention can be more fully understood by reading the subsequent detailed description and examples with reference to the accompanying drawings, wherein:

FIG. 1 is a schematic diagram illustrating an embodiment of a network structure of multi-media data sharing system of the invention;

FIG. 2 is a flowchart of an embodiment of a method for media data accessing of the invention;

FIG. 3 is a flowchart of another embodiment of a method for media data accessing performed on the gateway side of the invention;

FIG. 4 is a schematic diagram illustrating an embodiment of a torrent list of the invention; and

FIG. 5 is a schematic diagram illustrating an embodiment of a download task list of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The embodiments of the invention provide methods and systems for media data (e.g. audio and video data) accessing that combines UPnP and P2P (BT) on a residential gateway, allowing an internal networks like home/company network devices (e.g. PDA cell phone, UPnP appliances) to use UPnP protocol to locate and communicate with each other. Device (e.g. PDA or cell phone) may download shared media data from the Internet through an external P2P network via download package (e.g. BT).

In one embodiment, an open service gateway initiative (OSGi) platform is used to combine the UPnP device and the gateway to form OSGi service bundle. The bundle is than loaded into an OSGi receiver. OSGi bundle does not need to reboot for update, installation, and un-installation. The qualities are practical use for media data retrieval system. The service provider is able to remotely monitor the user's need and download applications or value-add services to the home gateway and automatically install services via any design that supports OSGi platform.

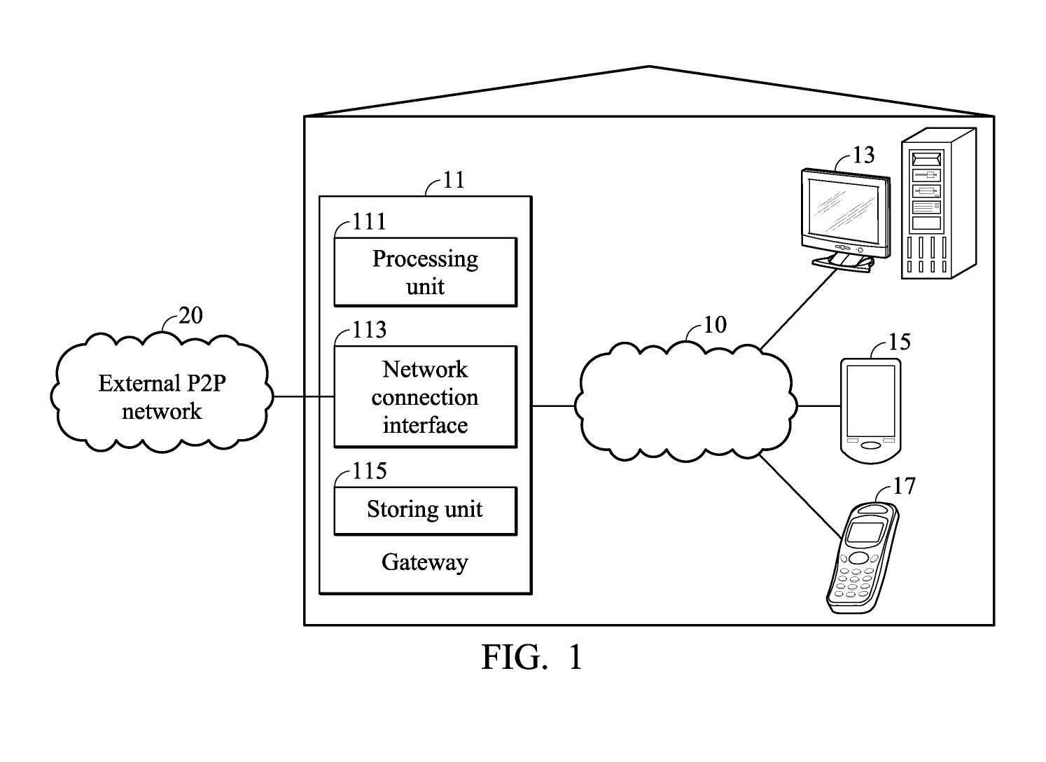

FIG. 1 is a schematic diagram illustrating an embodiment of a network structure of multi-media data sharing system of the invention. In a preferred embodiment, the network structure comprises an internal network 10 (e.g., a home network or a company network) and an external P2P network 20. The external P2P network 20 may be any network that allows P2P transfer outside of the internal network, such as the Internet. A gateway 11 and various UPnP devices may connect to the internal network 10. The UPnP devices may be any computer systems, electronic devices, and appliances that support the UPnP protocol. In this embodiment, the UPnP devices include a personal computer 13, a personal digital assist (PDA) 15, a cell phone 17, and a gateway 11. Within the network, the personal computer 13, the PDA 15, the cell phone 17, and the gateway 11 that function the UPnP protocol can connect and communicate through the UPnP protocol. The connection among the personal computer 13, the PDA 15, the cell phone 17 and the gateway 11 is based on many intermediate network nodes, e.g. access point, base station, hub, bridge, router or other intermediate node of network communication. In one embodiment, the internal network 10 comprises a home network and the gateway 11 comprises a standard home gateway that supports OSGi standard.

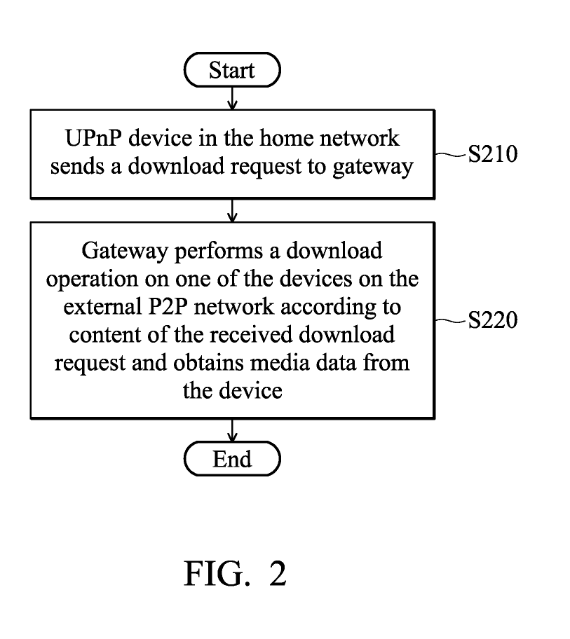

FIG. 2 is a flowchart of an embodiment of a method for media data accessing of the invention. In this embodiment, the personal computer 13 and the PDA 15 play the role of CP end in the UPnP protocol and the gateway 11 plays the device role of UPnP protocol. As aforementioned, the control point may control the operations of the devices and subscribe operation change events of the devices. Moreover, the control point may also connect two devices and transfer information between them.

The gateway 11 may connect to the external P2P network 20. There is a P2P software on the gateway 11, such as BT. Media data and files can be downloaded on the external P2P network 20 via BT. For illustration, BT software will be used in the following embodiment. BT takes information from a torrent file for download. The torrent records unique combined information so BT software can know what files are involved, source, how to download and other information. Each torrent may record the location of video file. The gateway 11 may receive such a torrent and obtain an address corresponding to the torrent file. It may then retrieve multiple video files according to the address and then sequentially append the retrieved videos for viewing.

The gateway 11 may comprise a processing unit 111, a network connection interface 113, and a storing unit 115. The processing unit 111 has the ability to perform dedicated tasks and may activate the P2P download software (such as BT) and perform the dedicated tasks. The network connection interface 113 may be any wired or wireless network interface which connects the physical network in wired or wireless connection such that the gateway 11 may obtain data from the connected network. In one embodiment, the gateway 11 may use the network connection interface 113 to connect with the external P2P network 20 and obtain data therefrom. The storing unit 115 may include the download program capable of performing above-mentioned torrent file. The downloaded result once the download is complete may also be stored in the storing unit 115. Download program may be one or more than one program for above-mentioned torrent file. For example, the download program may be a P2P download software. For example, the storing unit 115 of the gateway 11 may store source program of BT which allows the gateway 11 to perform download according to content of the torrent file of BT. The storing unit 115 may comprise a plurality of storing components, such as Flash, SRAM, hard drive and so on. Among those, there is an embedded system in the flash memory which is in charge of memory management and task schedule. The hard drive may include the above-mentioned download program.

First, in step S210, the UPnP device in the home network sends a download request to the gateway 11 to make the gateway 11 to execute download from the external P2P network 20. The UPnP device (such as the PC 13) may send a download request that includes the necessary download information for downloading from the external network such as download request for torrent or torrent URL.

Once the gateway 11 receives the download request that contains download information sent by the UPnP device of the home network, in step S220, the gateway 11 downloads content according to the received download request, performs download from one of the devices on the external P2P network 20, and thus obtains media data from this device. In this step, the gateway 11 may download data according to the information in the request to obtain the above-mentioned media data. For example, the download information may comprise related torrent or torrent URL of the download. When the download information represents a torrent, the gateway 11 directly uses the torrent for download. When the download information represent a URL form of the torrent, the gateway 11 may first obtain the torrent from this URL and then use the torrent for download. For example, if the download request includes a torrent, the gateway 11 may use BT to download from the external P2P network 20. If the download request includes the torrent URL, the gateway 11 may first use http protocol to connect to the torrent URL to download the torrent and then use BT to download from the external P2P network 20.

In one embodiment, in order to monitor the download status of each torrent and the subscription relationship between torrent and user more accurately, the method for media data accessing of the invention may further provide a list in the gateway 11 to keep track and manage activities. This chart is called torrent list (first list).

When the gateway 11 receives a user download request, it decides how to proceed with download according to the content of the request. In one embodiment, if the torrent in the download request does not exist in the torrent list of the gateway 11, the gateway 11 changes the torrent list by adding a new row to include the new torrent information and waits for the use of BT for download.

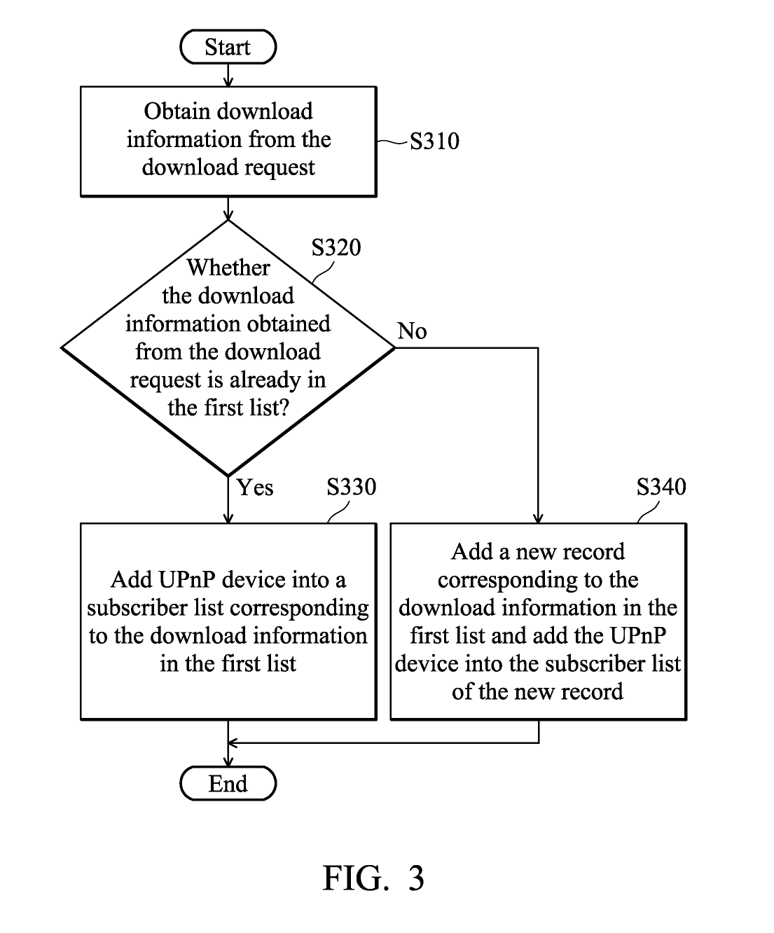

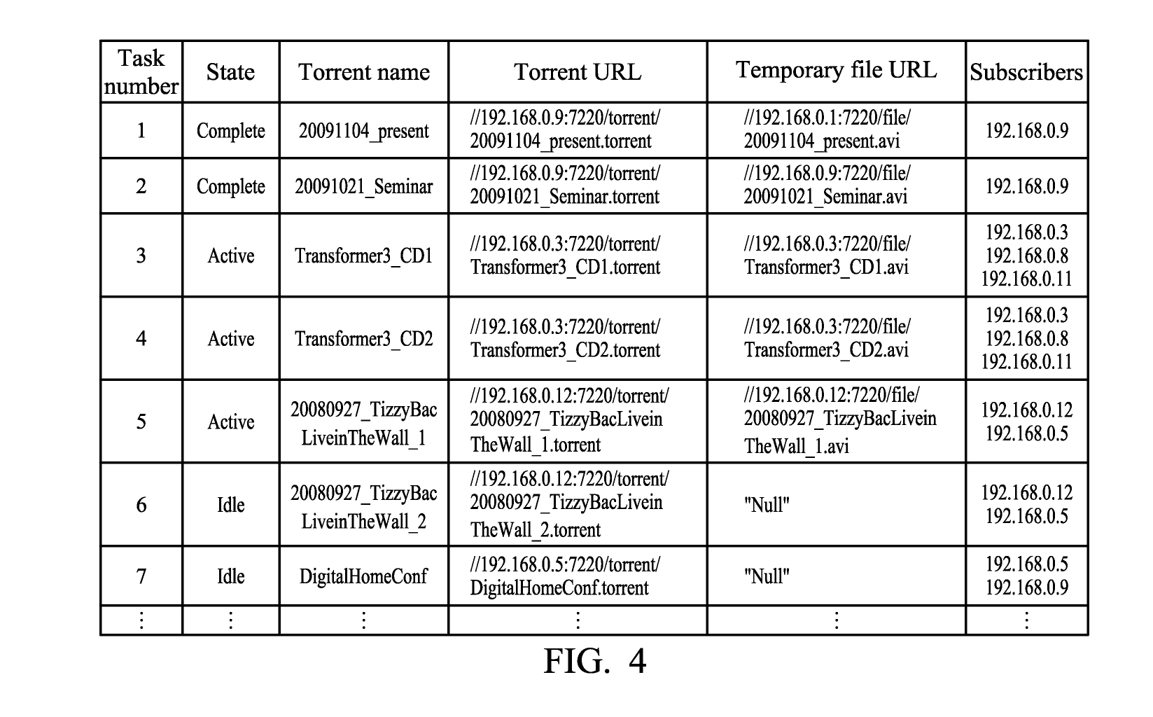

FIG. 3 is a flowchart of another embodiment of a method for media data accessing performed on the gateway side of the invention, which illustrates how the gateway 11 changes the torrent list according to the content of the received download request. For more details on the change in torrent list, please refer to the following FIG. 4.

After the download request is received, in step S310, the gateway 11 obtains download information from the download request. Note that the download information may include related torrent or torrent URL.

Then, in step S320, the gateway 11 determines whether the download information of the download request is already in the first list (torrent list) or not. If so, in step S330, showing existing download information in the first list, the UPnP device 13 is added to a subscriber list of the corresponding download information in the first list. If the download information does not exist in first list (No in step S320), which means that this is a new download information, in step S340, the gateway 11 adds new corresponding download information to the record of the first list and adds the UPnP device 13 into the subscriber list of the record.

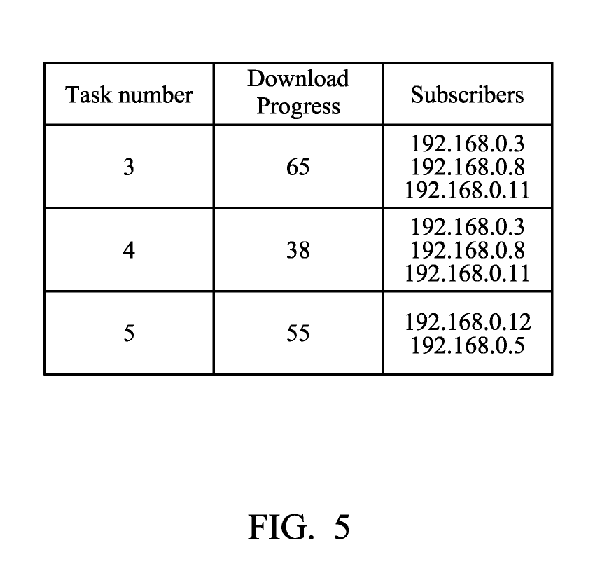

The first list may further include state information which marks the download status of each task. In one embodiment, the gateway 11 may further generate a second list (such as the download task list shown in the FIG. 5) according to the state information of first list. The second list is a sub-list of the first list. For more detail information about the first list and the second list, please refer to FIGS. 4 and 5.

FIG. 4 is a schematic diagram illustrating an embodiment of a torrent list of the invention. As shown in FIG. 4, a torrent list may include task number, status, torrent name, torrent URL, Temporary file URL, subscriber and other information. Task number information records corresponding task number, torrent name, and URL. State information records the current download status of the torrent. When the download status of the torrent changes, the content of the State information will be changed accordingly. When BT is not used for download, the State information is default to show “idle”. When BT is downloading, it shows “active”. Once the download is finished, it shows “complete”. In this embodiment, the media list shows lists of non-downloaded video (state information shows “idle”), downloading video (state information shows “active”), and download complete video (state information shows “complete”) for subsequent use. “Torrent name” information records the torrent name. “Torrent URL” information records the URL of the torrent file. Therefore, the gateway 11 may download torrent according to the “torrent name” and “torrent URL” information. “Temporary file URL” information shows where the unfinished download content is stored and the default of which is null. Once BT is used for downloading media, the program uses preset address to play the media once the download is done. Subscriber information records corresponding IPs of users that are interested in the torrent. IPs of subscribers or torrent users are also recorded here. In this embodiment, subscriber information may be used to obtain a subscriber list of the torrent. Referring to FIG. 4, the content of the torrent list shows corresponding task number as “3” and the status is “Active”. Torrent name is “Transformer3_CD1”. Torrent URL location is “//192.168.0.3:7220/torrent/Transformer3_CD1.torrent”. Temporary file URL is “//192.168.0.1:7220/file/Transformer3_CD1.avi.” Subscribers are “192.168.0.3,” “192.168.0.8” and “192.168.0.11.” The information means that task number 3 is downloading from Torrent URL location //192.168.0.3:7220/torrent/Transformer3_CD1.torrent. The download name is “Transformer3_CD1”, and there are “192.168.0.3,” “192.168.0.8,” and “192.168.0.11” three subscribers needing the file at the same time.

In one embodiment, the UPnP device in home network may send a subscription request to the gateway 11 to subscribe download status update. Thereafter, the gateway 11 may send events of download status to all subscribing UPnP devices in the subscriber list within the second list. For example, the gateway 11 may use the subscriber information in the list to obtain the subscriber list. In this embodiment, when BT is used for download, the state information in the list changes into “active” and includes the download in the download task list. It then performs an eventing notification according to the subscriber information in the download task list to perform media download progress update. When user sends the torrent to the gateway 11 via the UPnP device, it shows interest to the particular media. Therefore, the user may subscribe the update of download progress to the gateway 11 at the same time. On the other hand, if the torrent in the download request already exists in the torrent list of the gateway 11, the gateway 11 adds the user to the subscriber list of the torrent list and notifies download progress when the media is being downloaded.

The UPnP device in the home network may also send a request to the gateway 11 in order to obtain torrent (or media file) on the gateway and perform an operation. In one embodiment, the UPnP device may use the control mechanism of the UPnP protocol to control the torrent directory service (TDS) in the gateway 11 in order to obtain lists of non-downloaded, downloading, and completed media on the gateway 11. When the torrent list is obtained, the UPnP device may further perform an operation on the desired media file in the lists of non-downloaded, downloading, and complete media in the torrent list. If a file from the completed list is selected, it can be played on an appropriate media player. If a non-downloaded or downloading file is selected, the download progress update may be subscribed and the file may be played once the download is finished. In one embodiment, further operations, e.g. delete, pause, stop and so on, can be done once the desired media finishes downloading. For example, the UPnP device may use the control mechanism of UPnP protocol to send a request to the gateway for deleting or pausing media. Thereafter, the gateway 11 may perform corresponding delete or pause operation to the media via BT.

In one embodiment, the method for media data accessing of the invention may further provide a function of subscription to download progress update. It allows the UPnP device in the home network to subscribe to download progress update of media of interest in the gateway 11. By this subscription function, the user may be informed of the download progress of the media. Please refer to FIG. 4 and FIG. 5 for more detail list and mechanism descriptions.

In one embodiment, when the gateway needs to notify users of the download progress by eventing, only a portion of the sub-lists of the download task list will be sent within the eventing notification and required message will only be send to the subscribers, effectively reducing usage of network bandwidth for sending the list. For example, only the “active” ones in the torrent list are selected and use the state information and subscriber information to generate a sub-list. Please see FIG. 5.

FIG. 5 is a schematic diagram illustrating an embodiment of a download task list which is generated according to the state information within the torrent list of FIG. 4. Referring to FIG. 5, three items in the download task list indicate that the download progress corresponding to the task number “3” is 65% and the subscribers of which are “192.168.0.3”, “192.168.0.8” and “192.168.0.11”; the download progress corresponding to the task number “4” is 38% and the subscribers of which are “192.168.0.3”, “192.168.0.8” and “192.168.0.11”; and the download progress corresponding to the task number “5” is 55% and the subscribers of which are “192.168.0.12” and“192.168.0.5.” Therefore, corresponding download progress of the task number “5” will report the update periodically to“192.168.0.12” and“192.168.0.5.” Corresponding download progress of the task number 3 will report periodically to “192.168.0.3”, “192.168.0.8” and “192.168.0.11” and so on.

In one embodiment, this embodiment of the invention may further provide a way to be a torrent or stop being a torrent function for the external P2P network. The gateway may be used as a torrent, when BT has finished downloading, and intend to share media in the home network with the external network. Similarly, the UPnP device in the home network may also stop being the torrent to stop any external sharing function.

Therefore, methods for media data accessing and sharing of the invention combine the qualities of UPnP and P2P (such as BT) and transform the UPnP device in the internal network into a node in the P2P protocol. When there is a need to obtain media data from the external P2P network, the gateway in the internal network sends out requests which allow the UPnP device in the internal network to get media sharing from the external P2P network. Meanwhile, the UPnP device in the internal network may also share any media data to the external P2P network via the gateway.

The described embodiments for media data accessing in an intra network, or certain aspects or portions thereof, may be practiced in logic circuits, or may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a digital camera, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that can operate analogously to specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A method for media data accessing in an intra network, wherein the intra network is coupled to at least one universal plug-and-play (UPnP) device and a gateway, and the UPnP device communicates with the gateway using the UPnP protocol, the method comprising:
issuing, by the UPnP device, a request to the gateway; and
performing, by the gateway, a data download operation on a device in an external peer-to-peer (P2P) network to obtain a media data therefrom according to the received request.

2. The method of claim 1, further comprising:
sharing, by the UPnP device, a media data to the device in the external peer-to-peer (P2P) network a request to the gateway through the gateway.

3. The method of claim 1, further comprising:
sending, by the UPnP device, a subscription request to the gateway to subscribe for a download progress.

4. The method of claim 1, wherein the step of obtaining a media data by the gateway further comprises:
performing, by the gateway, the data download operation to obtain the media data according to a download information in the received request,
wherein when the download information represents a torrent, the gateway directly utilizes the torrent for downloading while when the download information represents a URL for a torrent, the gateway obtains the torrent from the URL and then performs the download operation utilizing the obtained torrent.

5. The method of claim 4, wherein the gateway further comprises a first list and the method further comprises:
determining whether the download information exists in the first list; and
when determining that the download information already exists in the first list, adding the UPnP device into a subscriber list corresponding to the download information in the first list.

6. The method of claim 5, further comprising:
when determining that the download information does not exist in the first list, adding a record corresponding to the download information in the first list and adding the UPnP device into the subscriber list of the record.

7. The method of claim 5, wherein the first list further comprises a state information and the method further comprises:
generating a second list from the first list based on the state information, wherein the second list is a sub-list of the first list; and
sending the second list to all of the subscribed UPnP devices in the subscriber list.

8. The method of claim 7, wherein the UPnP device further sends a request to the gateway to obtain the first list from the gateway.

9. The method of claim 8, wherein when obtaining the first list, the UPnP device performs an operation on the media data through the gateway according to media lists of non-downloaded, downloading, and completed items in the first list.

10. A system for media data accessing, comprising:
an intra network;
at least one universal plug-and-play (UPnP) device coupled to the intra network; and
a gateway coupled to the intra network, wherein the UPnP device communicates with the gateway using a UPnP protocol,
wherein the UPnP device issues a request to the gateway such that the gateway performs a data download operation on a device in an external peer-to-peer (P2P) network to obtain a media data therefrom according to the received request.

11. The system of claim 10, wherein the UPnP device further shares a media data to the device in the external P2P network.

12. The system of claim 10, wherein the UPnP device further sends a subscription request to the gateway to subscribe for a download progress.

13. The system of claim 10, wherein the gateway further performs the data download operation to obtain the media data according to a download information in the received request, wherein when the download information represents a torrent, the gateway directly utilizes the torrent for downloading while when the download information represents a URL for a torrent, the gateway obtains the torrent from the URL and then performs the download operation utilizing the obtained torrent.

14. The system of claim 13, wherein the gateway further comprises a first list and wherein the gateway further determines whether the download information exists in the first list and when determining that the download information already exists in the first list, the gateway adds the UPnP device into a subscriber list corresponding to the download information in the first list.

15. The system of claim 14, wherein when determining that the download information does not exist in the first list, the gateway adds a record corresponding to the download information in the first list and adds the UPnP device into the subscriber list of the record.

16. The system of claim 14, wherein the first list further comprises a state information and the gateway further generates a second list from the first list based on the state information and sends events of download status to all of the subscribed UPnP devices in the subscriber list within the second list, wherein the second list is a sub-list of the first list.

17. The system of claim 16, wherein the UPnP device further sends a request to the gateway to obtain the first list from the gateway.

18. The system of claim 17, wherein when obtaining the first list, the UPnP device further performs an operation on the media data through the gateway according to media lists of non-downloaded, downloading, and completed items in the first list.

19. The system of claim 10, wherein the intra network comprises a home network and the gateway comprises a home gateway that supports an open service gateway initiative (OSGi) platform.

20. A machine-readable storage medium comprising a computer program, which, when executed, causes a device to perform a method for media data accessing in an intra network, wherein the intra network is coupled to at least one universal plug-and-play (UPnP) device and a gateway and the UPnP device communicates with the gateway using the UPnP protocol, wherein the method comprises:
issuing, by the UPnP device, a request to the gateway; and
performing, by the gateway, a data download operation on a device in an external peer-to-peer (P2P) network to obtain a media data therefrom according to the received request.
